(19) United States
(12) Patent Application Publication
(10) Pub. No.: US 2021/0276071 A1
(43) Pub. Date: Sep. 9, 2021

(54) BENT TUBE AUTOMATION TOOLING

(71) Applicant: 3-D Solutions Design Service, LLC, Rockford, MI (US)

(72) Inventors: Cornell Chamberlain, Rockford, MI (US); Mark Hansen, Greenville, MI (US); Jeff Bannen, Greenville, MI (US)

(21) Appl. No.: 17/259,276

(22) PCT Filed: Jun. 17, 2019
(86) PCT No.: PCT/IB2019/055051

§ 371 Date: Jan. 11, 2021

Related U.S. Application Data
(60) Provisional application No. 62/820,528, filed on Mar. 19, 2019.
(60) Provisional application No. 62/696,721, filed on Jul. 11, 2018.

(51) Int. Cl. B21D 43/05; B21D 28/04; B21D 37/04; B21D 37/14; B25J 18/00

(52) U.S. Cl. CPC B21D 43/055; B21D 28/04; B25J 18/005; B21D 37/14; B21D 37/04

(57) ABSTRACT

A bent tubing automation tooling apparatus having a body component made of a rigid piece of material to connect an automation tooling machine to a work-piece manipulating implement, allowing for precision tooling with decreased parts and decreased setup, service, and tuning time to prepare the automation tooling machine for production. The body component may be a single monolithic body that is selectively movable between an operational position and an access position to provide for safer servicing of the automation tooling machine and components by allowing a technician to service the equipment from a safety zone instead of entering a dangerous area of the machine. The bent tubing apparatus provides fine tuning and quick adjustments to positional characteristics of the apparatus to increase precision of the automation tooling process while decreasing service time of the automation tooling machine and components.

### CROSS REFERENCE TO RELATED APPLICATION

The present application claims the priority benefits of International Patent Application No. PCT/IB2019/055051, filed Jun. 17, 2019, and claims priority of U.S. provisional application Ser. No. 62/696,721 filed Jul. 11, 2018 and Ser. No. 62/820,528 filed Mar. 19, 2019, which each are hereby incorporated herein by reference in their entireties.

### FIELD OF THE INVENTION

The present invention is directed to an attachment apparatus for use in automation tooling, specifically a bent tube apparatus for automation build-up between a transfer implement and an automation tooling machine.

### BACKGROUND OF THE INVENTION

Automation tooling requires precision movement of workpieces between specific locations and different machines. Automation tooling increases overall product quality due to the high level of precision attained through modern tools and machines available in the industry. The automation tooling industry requires skilled technicians and engineers to ensure that the tools, machines, systems, and software are setup, calibrated, tuned, and functioning properly and precisely to produce quality end products.

A key part in automation tooling is the build-up, or the structure, connecting an automation tooling machine to a workpiece manipulating element, such as a detachable implement, in order to move the workpiece as required for the job. The build-up is a critical component of the process and requires fine-tuning and service to provide the required precision needed in the automation tooling industry. The build-up is made up of any number of precision parts, assembled in many variations and positions, to allow an automation tooling machine to deliver a workpiece to a precise location within an automation workspace. The workpiece handling build-up typically includes a configured element that forms an elongated arm or arms that extend toward and contact the workpiece. The elongated arm or arms selectively hold and move the workpiece into and away from the work space, such as for example to move a workpiece into equipment for stamping, cutting, coining or other forming equipment.

During operation of workpiece handling build-ups it is not uncommon for operation to be interrupted in order to address a problem or other issue with the workpiece in the work space or with the forming equipment. In many such situations the build-up must be moved to gain access to the workpiece or work space. In such cases the build-up must be partially disassembled or adjusted to gain access to the workpiece or work space. The build-up must then be subsequently re-built or adjusted back into its operating condition, which is a time consuming process which requires particular positional tolerances to be recreated in order to handle the workpiece in the originally specified manner. In other situations the build-up may be left in position, but workers must then reach around the build-up to access the workpiece or work space and service the problem.

### SUMMARY OF THE INVENTION

The present invention provides an automation tooling build-up that is configured in a specified manner in order to handle and move workpieces relative to an automation workspace. The build-up includes a material handling region that may be selectively moved out of a specified operational position within the automation workspace to an access position outside of the automation workspace, and a registry device that is set at a registry position to relocate the material handling region to the specified operational position when moved back from the access position. With the preferred automation tooling build-up the material handling region may be moved out of the operational position in order to access or service the workpiece or work space, and then returned to the original specified operational position without having to undertake build-up adjustment or recalibration of the automation tooling build-up. Preferably, the material handling region of the build-up is moved between the operational position and access position by pivoting the material handling region or by lateral sliding of the material handling region.

According to one form of the present invention, an automation tooling build up is a bent tubing automation tooling build-up having a single body component made of a continuous rigid piece of material to connect an automation tooling machine to a piece of workpiece manipulating element, equipment, and/or implement, allowing for precision tooling with decreased parts and decreased setup, service, and tuning time required to prepare the automation tooling machine for production. The pivoting function of the present invention provides for safer servicing of the automation tooling machine and components by allowing a technician to service the equipment from a safety zone instead of climbing into a dangerous area or work zone of the machine. The single body bent tubing apparatus of the present invention provides fine tuning and quick adjustments to positional characteristics of the apparatus to increase precision of the automation tooling process while decreasing service time of the automation tooling machine and components. Optionally, the bent tube apparatus is configurable to support more than one body component to support large workpieces or to support more than one workpiece.

In one aspect of the present invention, the bent tube apparatus for automation tooling build-up is provided to precisely position, manipulate, and maneuver a workpiece within a workspace in proximity to the tooling machine. The bent tube apparatus includes a continuous rigid elongate body defining the build-up for the tooling process. The bent tube apparatus is configured to robustly connect to the automation tooling machine on at least one portion of the elongate body and configured to support a workpiece manipulating element, maneuvering region, or detachable implement at a distal end of the elongate body at a location apart from the tooling machine. Preferably, the elongate body includes at least one bend that enables the elongate body to accurately and precisely accommodate the workpiece within the workspace envelope in proximity to the tooling machine and to allow the bent tube apparatus to effectively manipulate the workpiece. Alternatively, the elongated body may be made up of multiple connected sections of tubing that are coupled together in a specified configuration and may be maintained for repeated use in that configuration or alternatively assembled into different configurations for alternative applications.

In one aspect, the bent tube apparatus is releasably coupled to the automation tooling machine with a securing device, such as a primary clamp. The securing device is configured to mate with a mount on the automation tooling machine at one end and to couple to the elongate body on the opposing end. The releasable securing device allows for an operator or technician to quickly install a bent tube apparatus, or to remove and replace one bent tube apparatus with another, each configured for a specific automation tooling operation. The securing device machine-side mount may be one of various forms, including commercially available mounts or a custom mount system.

In another aspect of the present invention, the bent tube apparatus is pivotally coupled to the automation tooling machine with a pivotable securing device, such as a primary clamp. The pivotable securing device is able to be loosened by a technician such that the technician can pivot the bent tube apparatus from a working orientation to a service orientation. The service orientation providing the technician access to the tooling build-up to perform maintenance on the build-up or to remove and replace the build-up with a different bent tube apparatus without having to enter a dangerous area within the tooling machine to do so. After the technician has completed their task, the bent tube apparatus is returned to the working orientation and the securing device is tightened to secure the bent tube apparatus in the working orientation.

In another aspect, the bent tube apparatus is fixedly coupled to the automation tooling machine, such as with a transfer rail mount. The transfer rail mount allows an operator to loosen and remove the bent tube apparatus and to replace it with a different tube for a different task or operation. The fixed coupling of the bent tube apparatus and the automation tooling machine provides simple, low-maintenance, and cost effective workpiece manipulation.

In one aspect, the bent tube apparatus includes a retaining system configured to retain the elongate body from moving from side to side relative to the securing device. In one aspect, the retaining system includes at least one tube clamp positioned abutting the securing device. The retaining system ensures that during movement of the bent tube apparatus from a working orientation to a service orientation, and back, that the bent tube apparatus returns to the precise defined location required for the tooling procedure without shifting laterally relative to the tooling machine. The at least one tube clamp of the retaining device is operable to be loosened from and tightened onto the elongate body to allow a technician to change or reposition the elongate body from side to side to fine tune the precision of the apparatus relative to the required position of the workpiece.

In one aspect, the distal end of the elongate body includes a workpiece manipulating element to manipulate a workpiece during operation of the automation tooling machine. The workpiece manipulating element may include a detachable workpiece manipulating implement or head coupled to the distal end of the elongate body. The detachable implement may be a variety or commercially available workpiece manipulating systems, such as suction cups, magnets, clamping devices, shovels, or the like. The manipulating implements are detachable such that a technician can quickly remove one implement and replace it with another for a different operation.

In another aspect, the workpiece manipulating element at the distal end of the elongate body may include an integral workpiece manipulating portion or region, such that the distal end of the elongate body includes a notch or slot disposed through or in the elongate body material defining a specific type of manipulating element. The workpiece manipulating element may be defined by a variety of shapes, such as a shovel. Integral notches and slots reduce weight of the build-up and decrease the amount of parts to be configured for the tooling production being performed, thereby decreasing possible sources of vibration, reducing stress in the system, decreasing energy used, and increasing speed of tooling processes.

In one aspect of the present invention, the bent tube apparatus includes an adjusting element or set-stop disposed at a portion of the elongate body at a location proximate to the automation tooling machine, such as near a transfer rail of the machine. The adjusting element is configured to adjust at least one position characteristic of the bent tube apparatus to precisely position the bent tube apparatus as required relative to the automation tooling machine.

In one aspect, the adjusting element is a threaded bolt threaded into a threaded insert that is disposed within the elongate body. The threaded bolt passes into and through the elongate body and contacts a proximate location on the automation tooling machine to provide a physical contact interaction between the threaded bolt and the tooling machine. The threaded bolt is turned clockwise or counter-clockwise to adjust the position characteristic of the bent tube apparatus relative to the tooling machine. The interaction between the threaded bolt and the tooling machine provides a set-stop position wherein the bent tube apparatus can be returned to a desired working orientation that has been set by the technician after the technician has finished a task, such as performing maintenance on the material handling implement. The set-stop position enables the return of the bent tube apparatus to a precise location after it has been moved between the working orientation and a service orientation without additional adjustment or time needed to reposition the bent tube apparatus. In this aspect, after the technician has completed their task, the bent tube apparatus can be returned to the working orientation where the adjusting element of the bent tube apparatus contacts a portion of the tooling machine at the set-stop position and the bent tube apparatus is back in the working orientation. The threaded insert may be a rivet type threaded insert, a nylon plug type threaded insert, or similar threaded element disposed in the elongate body. Optionally, the adjusting element includes a pivotable contact head configured to provide optimal contact between the adjusting element and the tooling machine.

In another aspect, the adjusting element is disposed in at least one of the releasable clamps of the retaining system, such that no hole is required through the elongate body and no additional material is required beyond the section of the elongate body that is secured to the automation tooling machine. Optionally, the adjusting element includes a pivotable contact head configured to provide optimal contact between the adjusting element and the tooling machine.

According to another form of the present invention, a bent tube apparatus is configured to support more than one elongate body, wherein each elongate body is configured to support a workpiece manipulating element. Each elongate body is independently adjustable relative to a securing device. Each of the multiple elongate bodies are provided for manipulating one workpiece or may cooperate to manipulate a single larger workpiece.

According to another form of the present invention, a continuous rigid elongate body of the bent tube apparatus is formed from a single elongate member of material, such as steel or aluminum, which is bent based on volumetric data from a three-dimensional model. A software program may be used to model an elongated body to perform a specific process, wherein the software program outputs the data of the model to a material bending machine that then bends the elongate member to the specification of the model.

Therefore, the present invention provides a bent tubing automation tooling build-up apparatus for connecting a workpiece maneuvering element to an automation tooling machine to precisely maneuver and manipulate a workpiece within a workspace envelope while utilizing a minimal number of parts. Limiting the number of parts decreases weight, increases precision, decreases setup, service, maintenance, and tuning time, decreases costs, increases productivity, and provides additional benefits as compared to traditional automation tooling build-ups. The single precision-bent, machined, or milled elongate body provides a versatile connection type between an automation tooling machine and the workpiece to be manipulated.

These and other objects, advantages, purposes and features of this invention will become apparent upon review of the following specification in conjunction with the drawings.

### BRIEF DESCRIPTION OF THE DRAWINGS

FIG. 1 is a perspective view of an embodiment of a bent tubing apparatus embodying the invention for attachment between an automation tooling system, such as a transfer rail, and a workpiece manipulating implement;

FIG. 2 is a perspective view of an embodiment of a bent tubing apparatus coupled to an attachment clamp configured to mount to a transfer rail;

FIGS. 3A-3D are perspective views of the bent tubing apparatus including various alternative types of workpiece manipulating element with different workpiece handling configurations, such as shovels, notches, or mounts for a workpiece manipulating device, for lifting or transferring a workpiece and embodying the invention;

FIGS. 4A-4B are a perspective view and a side view illustrating a rotation of the bent tube apparatus from a working orientation or operational position to a non-working orientation or access orientation shown in phantom, such as out of a working area to an adjustment and manipulation area for safely adjusting or servicing the bent tube apparatus;

FIGS. 5A-5B are perspective views of an embodiment of the bent tubing apparatus having more than one workpiece handling arm for supporting larger workpieces or more than one workpiece;

FIG. 6 is a perspective view of another embodiment of the bent tubing apparatus having more than one workpiece handling arm for supporting larger workpieces or more than one workpiece.

FIG. 7 is a perspective view of a bent tubing apparatus configured to mount directly to a transfer rail.

### DESCRIPTION OF THE PREFERRED EMBODIMENTS

Referring now to the drawings and the illustrative embodiments depicted therein, an automation tooling build-up apparatus is defined by an elongated rigid body that is configured to provide precision support or manipulation functionality between a workpiece and an automation tooling machine, such as a transfer press machine. The elongated body may be formed from a precision bent or shaped single piece of material, thereby minimizing the required number of parts or members required to form the build-up. Minimizing the number of build-up parts reduces the need for time-consuming and imprecise adjustment of the tooling system and increases production throughput. The elongated body may be mechanically formed automatically using a software controlled machine to shape the elongated body based on information from a three-dimensional model, such as with a computer numerical controlled (CNC) machine. The elongated body may alternatively be mechanically formed manually by a technician using manual tools and/or manually controlled machines.

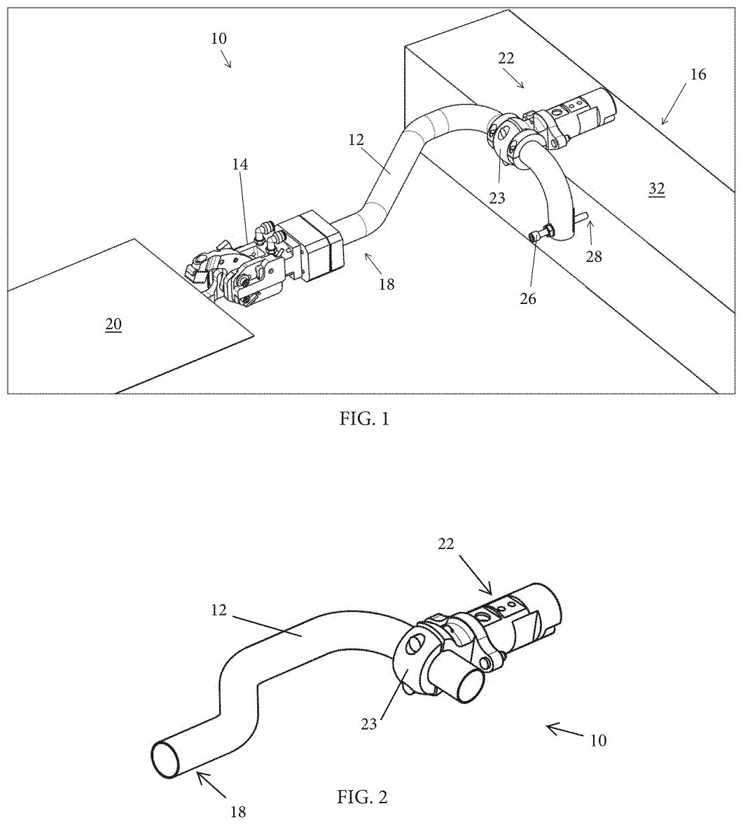

Referring to the illustrated embodiments of FIGS. 1-4A, a bent tubing automation tooling or build-up apparatus 10 having a continuous elongated rigid body 12 is configured to provide precision support between a part or workpiece and an automation tooling machine 16, such as a transfer machine. The elongated body 12 is formed as a precision bent single continuous or monolithic piece of material to enable precision maneuvering of a workpiece 20 using a tooling or transfer machine 16 without the need for time-consuming and imprecise adjustment of multi-piece build-up tooling systems. The elongated rigid body 12 includes a workpiece manipulating element 14, such as an integral notch or a detachable implement, disposed at a distal end 18 of the elongated body 12 to support or grip the workpiece 20. The bent tubing apparatus 10 is configured such that the workpiece 20 and the tubing apparatus 10 are maneuverable proximate the tooling machine 16 without contacting, clashing, or impeding clearance with other proximate parts of the tooling machine 16. As illustrated in FIGS. 1-3D, the manipulating element 14 may by coupled to or disposed in the elongated body 12 and may be selected from any type of machine tooling implement configured to maneuver or manipulate a workpiece 20, such as suction cups, magnets, clamping devices, shovels, or the like. Alternatively elongated body may be made up of connected components or pieces that are locked into a rigid configuration or joined by welding or other joining processes, but preferably once made up in the desired configuration is used and maintained in a set configuration.

The elongated body 12 may be composed of a rigid, resilient material that is capable of being precision bent, machined, or milled, such as steel, stainless steel, aluminum, plastic, or the like. The elongated body 12 may be produced off-site to a required specification and installed onto an automation tooling machine 16, greatly simplifying changeover procedures and reducing the time required for a technician to reconfigure the build-up for a new tooling configuration. Optionally, a software-controlled forming machine may form the elongated body 12 based on three-dimensional volumetric information as provided by the software that controls the forming machine. Preferably, elongated body 12 is a single continuous or monolithic body, but alternatively may be made up of multiple components or elements and then fixed into a rigid configuration.

A machine securing device 22, such as a releasable primary clamp or an adaptor for coupling with a receiver, is coupled to a portion of the elongated body 12 to provide a robust connection between the tooling machine 16 and the tubing apparatus 10. In addition, the tubing apparatus 10 may include features such as a releasable and pivotable clamp 23 disposed with the securing device 22 and configured to allow safe maintenance of the tubing apparatus 10, releasable retaining clamps 24 configured to retain the tubing apparatus 10 at a desired location relative to the pivotable clamp 23, position adjustment systems 26 provided to fine-tune at least one position characteristic of the tubing apparatus 10, which may provide a position return set registry or set-stop provided to facilitate the return of the tubing apparatus 10 to a pre-determined position if it has been pivoted at the pivotable clamp 23. Thus, the bent tubing automation tooling apparatus 10 greatly simplifies the setup and changing of an automation build-up from one operation configuration to the next configuration, while also providing increased safety to a technician by allowing the technician to maintain or remove the build-up from a safe location relative to the automation tooling machine.

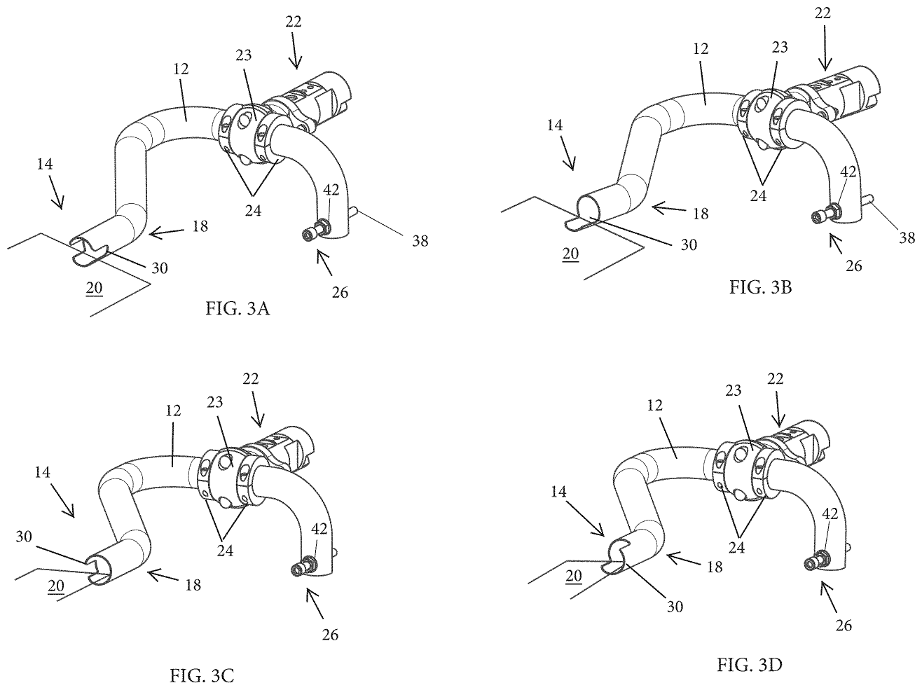

As shown in the illustrative embodiments of FIGS. 3A-3D, the manipulating element 14 may be integrally disposed within the elongated body 12 at the distal end 18. The manipulating element 14 disposed within the distal end 18 may be defined as a slot or notch 30 cut or machined into the distal end 18. Various shapes of slots or notches 30 may be utilized to perform differing operations, shapes such as: a slot to lift and tilt the workpiece 20 as shown in FIG. 3A; a bottom shovel to support a workpiece 20 from below as shown in FIG. 3B; a notch through one side of the distal end 18 to lift and tilt the workpiece 20 while limiting lateral movement of the workpiece 20 as shown in FIG. 3C; a shovel with varying side wall heights to support a workpiece from below while limiting lateral movement of the workpiece 20 as shown in FIG. 3D. It will be appreciated that other notch and slot shapes are configurable to support and maneuver a workpiece 20.

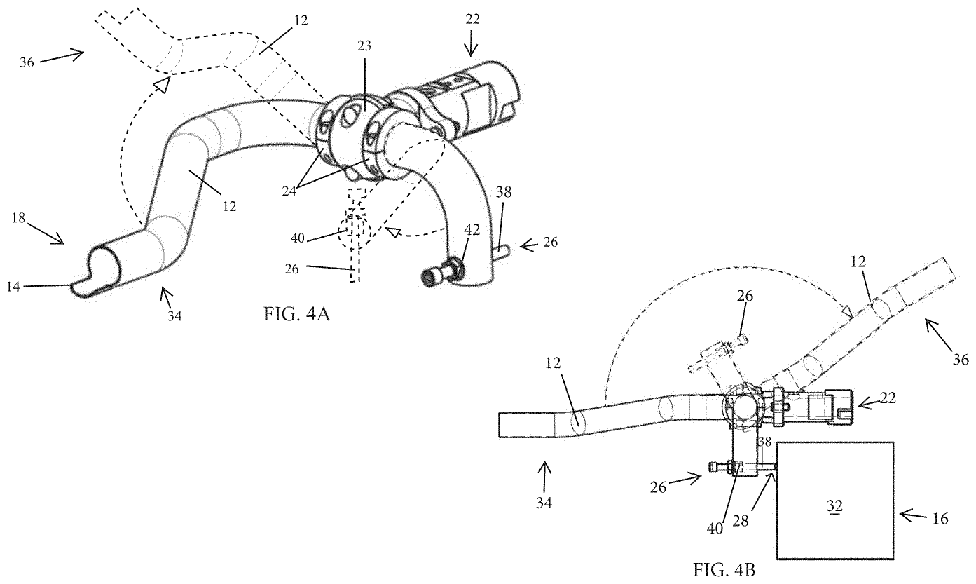

Referring to the illustrative embodiment of FIGS. 4A-4B, the tubing apparatus 10 is pivotally coupled to a transfer rail 32 of the automation tooling machine 16 such that an operator or technician may pivot the tubing apparatus 10 from a potentially dangerous working orientation or position 34 to a service orientation or position 36 to allow for safer access to service the build-up tooling of the automation tooling machine 16. The tubing apparatus 10 is pivotable after a pivotable clamp 23 of the securing device 22 is loosened, such that the tubing apparatus 10 is freely pivotable about the axis passing through the axial center of the pivotable clamp 23. A retaining system defined by the releasable retaining clamps 24 is provided to retain the position of the elongated body 12 from sliding laterally or side to side relative to the pivotable clamp 23 while allowing the tubing apparatus 10 to pivot about the axial axis of the pivotable clamp 23. Rotational adjustment of the tubing apparatus 10 is provided by the pivotable clamp 23, such that the elongated body 12 is rotatable at the pivotable clamp 23 while the clamp 23 is loosened. The technician can set the rotational position of the elongated body 12 relative to the pivotable clamp 23 by tightening the clamp 23. Positional adjustment of the tubing apparatus 10 is provided by the releasable retaining clamps 24, such that the elongated body 12 is slideable through the releasable retaining clamps 24 while the clamps 24 are loosened. The technician can set the position of the elongated body 12 relative to the releasable retaining clamps 24 by tightening the clamps 24.

The elongated body 12 may be moved between the operational or working position 34 and an access or service position 36 by releasing the pivotable clamp 23 and one of retaining clamps 24 while maintaining the clamped state of the other retaining clamp 24. In this released adjustment position elongated body 12 is laterally slidable through pivotable clamp 23 with the released retaining clamp 24 sliding along the lateral length of elongated body 12 until an access position is achieved that provides sufficient desired clearance between the elongated body 12 and the work space or forming equipment. After service is completed elongated body is slid back through pivotable clamp 23 until the clamped retaining clamp 24 is contacted and released retaining clamp 24 is slid back to the original clamping position. Both the pivotable clamp 23 and the released retaining clamp 24 are tightened into a clamped condition while a position adjustment element or system, such as in the form of a position return set registry 26 maintains registry with transfer rail 32 and proper positioning of elongated body 12.

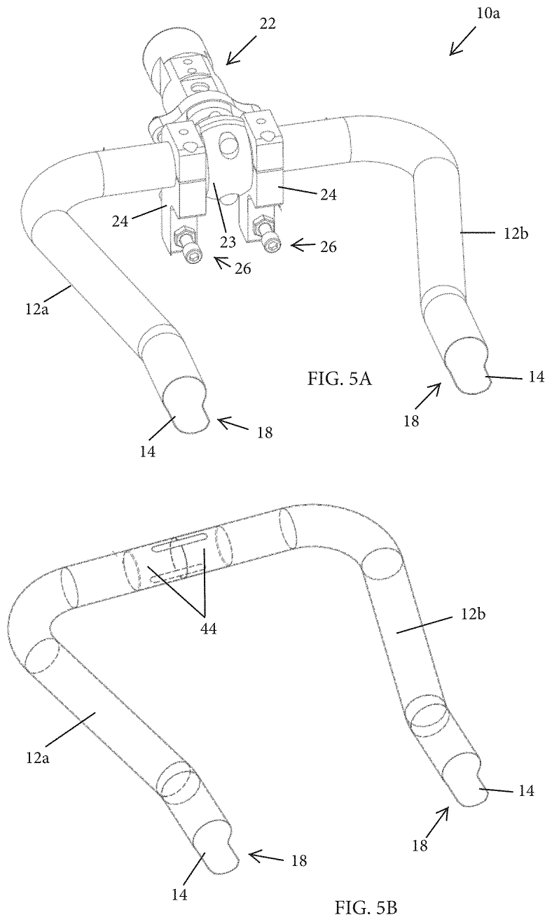

The position adjustment system 26 is disposed on the tubing apparatus 10 proximate the automation tooling machine 16. The position adjustment system 26 is operable to fine tune a position characteristic of the tubing apparatus 10, such as the rotation of the apparatus 10 about the pivotable clamping axis defined previously. In the illustrative embodiment of FIGS. 4A-4B, the position adjustment system 26 is a threaded bolt 38 threading into a threaded insert 40 disposed in a portion of the elongate body 12, the threaded bolt 38 passing through the opposite wall of the elongated body 12. The position adjustment system is adjustable by turning the threaded bolt 38 clockwise or counter-clockwise to adjust the position characteristic of the tubing apparatus 10 as desired. Optionally, the position adjustment system 26 includes a jam nut 42 disposed on the threaded bolt 38 to ensure the threaded bolt 38 does not loosen during operation of the automation tooling machine 16. The threaded insert 40 may be any form of fixed or fixable threaded insert, such as a press fit insert, a machinable nylon plug, tapping and threading the elongated body 12, or the like. In an alternative embodiment, as illustrated in FIG. 5A, the position adjustment system 26 is disposed on at least one of a releasable retaining clamp 24.

The position adjustment system 26 includes a set-stop or contact head 28 and is configured to provide a set registry or position, such that when the tubing apparatus 10 is pivoted between the working orientation 34 and the service orientation 36, the technician simply pivots the tubing apparatus 10 back to the working orientation 34 and the set-stop 28 makes contact with a portion of the automation tooling machine 16, such as the transfer rail 32, thus returning the tubing apparatus 10 to the desired working orientation 10 without measurement or adjustment. The set-stop 28 is defined by a point of contact between the position adjustment system 26 and the automation tooling machine 16. The registry 26 and set-stop 28 maintain the relative position or calibration of tubing apparatus 10 relative to transfer rail 32 by maintaining the registry between set-stop 28 and transfer rail 32. Optionally, the position adjustment system 26 or set-stop 28 includes a pivoting contact head configured to pivot about the distal end of the threaded bolt 38 until it contacts the transfer rail 32 and continues to pivot until the contacting portion of the contact head is uniformly in contact with the transfer rail 32 ensuring that the position adjustment system 26 is in stable contact with the transfer rail 32 at the set-stop 28.

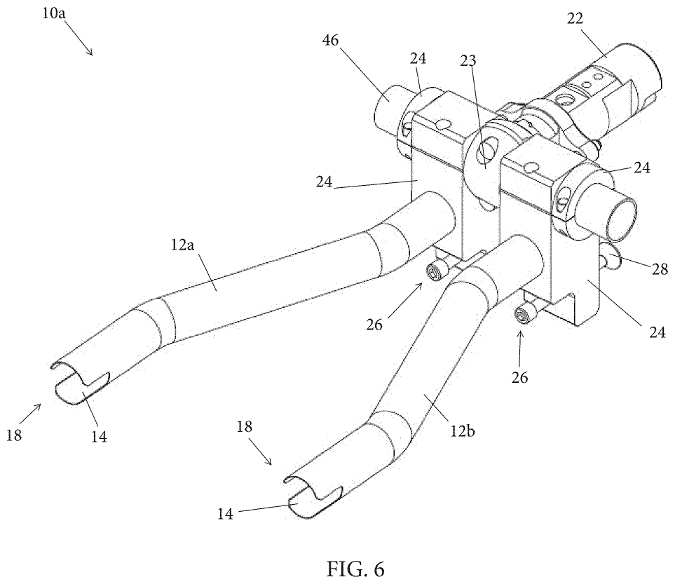

Referring to the illustrative embodiment of FIGS. 5A-6, a tubing apparatus 10a is configured to include more than one workpiece manipulating element 14. The tubing apparatus 10a is configurable to support at least two continuous elongated rigid bodies 12a, 12b, each configured to provide precision support between a part or workpiece manipulating element 14 and an automation tooling machine 16, such as a transfer machine. Each of the elongated bodies 12a, 12b are adjustable independent of the other within the pivotable clamp 23 and the releasable retaining clamps 24. In one embodiment, a piece of round stock 44 is inserted between proximal ends of elongated bodies 12a, 12b to provide optimal clamping strength beneath the pivotable clamp 23 and the releasable retaining clamps 24 to prevent crushing or pinching at the proximal ends of elongated bodies 12a and 12b. In another embodiment, as illustrated in FIG. 6, proximal ends of elongated bodies 12a, 12b are disposed into the releasable retaining clamps 24 perpendicular to the transfer rail 32, and the retaining clamps 24 are coupled to the securing device 22 with a piece of round stock 46 axially inserted through the retaining clamps 24 and the pivotable clamp 23. The elongated bodies 12a, 12b are independently releasable and pivotable at their respective retaining clamps 24, such that one of elongated bodies 12a, 12b may be moved out of or into the work zone independent of the other. Optionally, the elongated bodies 12a, 12b may be pivoted together about pivotable clamp 23 to be moved out of or into the work zone.

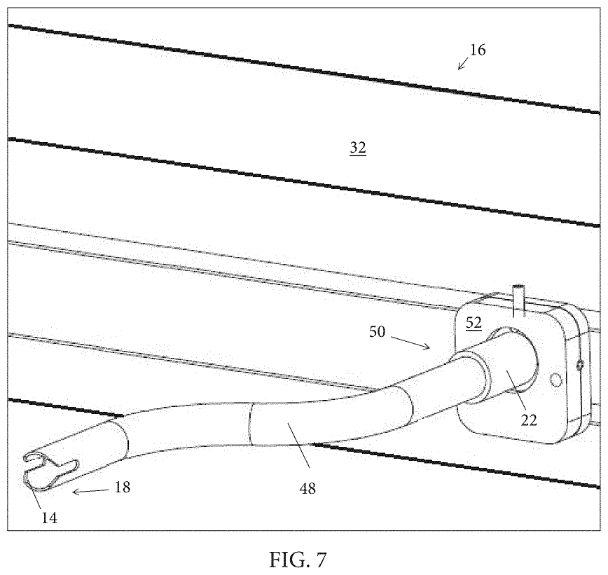

Referring to the illustrative embodiment of FIG. 7, an elongated body 48 is fixedly coupled at a proximal end 50 to a transfer rail mount 52. The elongated body 48 is configured to rigidly attach to the transfer rail 32 to provide a simple and cost effective precision support between a part or workpiece manipulating element 14 and an automation tooling machine 16, such as a transfer machine. The elongated body 48 is not pivotally coupled to the automation tooling machine 16.

The rigid elongate body 12 of the bent tube apparatus 10 may be formed from a single, continuous and monolithic member of material, such as steel or aluminum, which is bent, shaped, or formed based on three-dimensional volumetric data, such as from a software based model. A software program may be used to model an elongated body to perform a specific process, whereby the software program outputs the data of the model to a material bending machine that then bends the elongate member to the specification of the model.

Optionally, wiring for sensors and air lines for pneumatic clamping devices can be run through an interior of the elongate tubing 12 to prevent it from snagging, pinching, or damaging of the wiring or airlines during operation of the automation tooling machine 16.

Accordingly, the automation tooling build-up apparatus of the present invention provides a single body component made of a continuous rigid piece of material to connect to an automation tooling machine and to support a workpiece or a workpiece manipulating implement, allowing for precision automation tooling with decreased parts and decreased setup, service, and tuning time required to prepare the automation tooling machine for production. The build-up includes a material handling region that may be selectively moved out of a specified operational or working position to an access or service position. A registry device that is set at a registry position may be included to relocate the material handling region to the specified operational position when the build-up apparatus is moved between the operational position and the access position. The selectively movable function provides for safer servicing of the automation tooling machine and components by allowing a technician to service the equipment from a safety zone instead of climbing into a dangerous area or work zone of the machine. Optionally, the bent tube apparatus is configurable to support more than one body component to support large workpieces or to support more than one workpiece. The single body component may be formed with the aid of a three-dimensional volumetric data, such as with a three-dimensional modeling software.

Changes and modifications in the specifically described embodiments can be carried out without departing from the principles of the present invention which is intended to be limited only by the scope of the appended claims, as interpreted according to the principles of patent law including the doctrine of equivalents.

1. A bent tube apparatus for automation build-up between a workpiece to be manipulated and an automation tooling machine, comprising:
a rigid elongate body configured to position a workpiece at a location apart from the automation tooling machine, said rigid elongate body removably coupled at a proximal end to the automation tooling machine, said rigid elongate body comprising a monolithic region;
a workpiece manipulating element disposed at a distal end of said elongate body opposite of the automation tooling machine, said workpiece manipulating element configured to manipulate the workpiece; and
a bend in said monolithic region of said elongate body to accommodate the workpiece within a movement envelope available within a workspace proximate to the automation tooling machine, said bend located at a portion of said monolithic region in a manner that positions the workpiece manipulating element at a precise location within the workspace.

2. (canceled)

3. (canceled)

4. The bent tube apparatus of claim 1, further comprising a securing device coupled to the automation tooling machine and configured to couple a portion of said elongate body to the automation tooling machine, wherein said elongate body is at least one chosen from releasably coupled to said securing device and pivotally coupled to said securing device.

5. (canceled)

6. The bent tube apparatus of claim 4, further comprising a retaining system configured to retain a portion of said elongate body proximate to said securing device, such that said bent tube apparatus is pivotable, without lateral movement relative to said securing device, between a service position in which said workpiece manipulating element is adjacent to the workspace and a working position in which said workpiece manipulating element is within the workspace to perform a function.

7. The bent tube apparatus of claim 6, wherein said retaining system comprises a clamp releasably coupled to said elongate body.

8. The bent tube apparatus of claim 1, wherein said workpiece manipulating element is disposed at a distal end of said elongate body and comprises at least one chosen from a slot formed in the distal end of said elongate body and a detachable workpiece manipulating head coupled at the distal end of said elongate body, wherein said slot is configured to manipulate the workpiece directly with at least a portion of said elongate body and wherein said detachable workpiece manipulating head is configured to perform a function, said detachable head is interchangeable with another detachable head configured to perform another function.

9. (canceled)

10. The bent tube apparatus of claim 1, further comprising an adjusting element disposed at a portion of said elongate body, wherein said adjusting element is configured to adjust at least one position characteristic of said bent tube apparatus.

11. (canceled)

12. The bent tube apparatus of claim 6, further comprising an adjusting element disposed at a portion of said retaining system, wherein said adjusting element is configured to adjust at least one position characteristic of said bent tube apparatus.

13. A bent tube apparatus for automation build-up between a workpiece to be acted upon and an automation tooling machine, comprising:
a rigid elongate body configured to position a workpiece manipulating element at a precise location apart from the automation tooling machine;
a pivotable clamp coupled to said elongate body and mountable to the automation tooling machine, said pivotable clamp selectively operable to pivot said elongate body relative to the automation tooling machine; and
a registry element coupled with said bent tube apparatus and;
operable to provide a set registry position for said bent tube apparatus relative to the automated tooling machine such that when said elongate body is pivoted relative to said pivot clamp said bent tube apparatus is returnable to a working position in which said workpiece manipulating element is within an automation workspace proximate the automation tooling machine and at the precise location apart from the automation tooling machine.

14. The bent tube apparatus of claim 13, wherein said rigid elongate body comprises a substantially continuous, monolithic body.

15. (canceled)

16. (canceled)

17. A method for manipulating a workpiece, said method comprising:
coupling a bent tube tooling build-up apparatus to an automation tooling machine, said bent tube apparatus comprising an elongate body coupled at a proximal end to the automation tooling machine at a pivotable clamp;
moving said bent tube apparatus to a working position relative to the automation tooling machine by moving said bent tube apparatus about theft pivotable clamp; and
manipulating the workpiece by operating the automation tooling machine while said bent tube apparatus is in the working position.

18. The method for manipulating a workpiece of claim 17, further comprising performing service on the bent tube apparatus by pivoting the bent tube apparatus about the pivotable clamp away from the working position to the service position, servicing the bent tube apparatus, and pivoting the bent tube apparatus about the pivotable clamp back to the working position.

19. The method for manipulating a workpiece of claim 17, further comprising
providing a set registry position between the automated tooling machine and said bent tube apparatus and
selectively adjusting the set registry position by adjusting a registry element coupled with said bent tube apparatus, said registry element operable to provide a selectively adjustable contact with at least one chosen from a surface on the automation tooling machine and a portion of the pivotable clamp workpiece.

20. (canceled)

21. The bent tube apparatus of claim 1, wherein said rigid elongate body comprises a substantially continuous, monolithic body.

22. The bent tube apparatus of claim 6, further comprising a registry element coupled with said elongate body and configured to contact a surface on the automation tooling machine when said bent tube apparatus is in the working position, said registry element is selectively adjustable to provide a set registry between the automated tooling machine and said elongate body such that when said bent tube apparatus is moved between the working position and the service position said bent tube apparatus is automatically returnable to the desired set working position.

23. The bent tube apparatus of claim 10, further comprising a registry element coupled with said elongate body and configured to contact a surface on the automation tooling machine when said bent tube apparatus is in the working position, said registry element is selectively adjustable to provide a set registry between the automated tooling machine and said elongate body such that when said bent tube apparatus is moved between the working position and the service position said bent tube apparatus is automatically returnable to the desired set working position.

24. The bent tube apparatus of claim 13, further comprising a retaining system configured to retain a portion of said elongate body proximate to said pivotable clamp, such that said bent tube apparatus is pivotable, without lateral movement relative to said pivotable clamp, between the working position in which said workpiece manipulating element is within the automation workspace and a service position in which said workpiece manipulating element is adjacent to the automation workspace.

25. The bent tube apparatus of claim 24, further comprising an adjusting element configured to adjust at least one position characteristic of said elongate body relative to said retaining system.

26. The bent tube apparatus of claim 13, wherein said workpiece manipulating element comprises at least one chosen from a slot formed in the distal end of said elongate body and a detachable workpiece manipulating implement configured to perform a function, wherein said detachable implement is interchangeable with another detachable implement configured to perform another function.

27. The bent tube apparatus of claim 13, wherein said registry element is selectively adjustable.

28. The method for manipulating a workpiece of claim 17, further comprising preparing the elongate body of the bent tube apparatus by mechanically forming the elongate body with a software controlled machine, wherein the elongate body comprises a monolithic region having a bend located at a portion of said monolithic region in a manner that positions the workpiece manipulating element at a precise location within an automation workspace.
